(19) United States
(12) Patent Application Publication
(10) Pub. No.: US 2001/0045159 A1
(43) Pub. Date: Nov. 29, 2001

(54) Filter-fan product including a circuit for monitoring the filter thereof

(76) Inventors: William A. Johnson, Holliston, MA (US); Martin Larry, Tiverton, RI (US)

Correspondence Address: Charles R. Hoffmann, Esq., HOFFMANN & BARON, LLP, 6900 Jericho Turnpike, Syosset, NY, 11791, US

(21) Appl. No.: 09/761,168

(22) Filed: Jan. 12, 2001

Related U.S. Application Data
(60) Provisional application No. 60/176,355, filed on Jan. 14, 2000.

(51) Int. Cl. B01D 46/46

(52) U.S. Cl. 95/26; 96/424

(57) ABSTRACT

A method and circuit for monitoring the useful life of a filter for a filter-fan product. The method includes the steps of detecting use of a fan of the filter-fan product with a microprocessor, counting from a predetermined initial counter value a duration of usage of the fan with a counter of the microprocessor to determine a present counter value, sending a signal representing the present counter value from the microprocessor to a display and displaying the remaining useful life of the filter based on the signal received from the micro processor. Use of the fan is preferably detected by detecting a position of a fan speed switch such that the microprocessor detects the speed of the fan and adjusts the rate of counting by the counter based on the detected speed of the fan. The circuit includes a microprocessor electrically connected to a fan of the filter-fan product for detecting use of the fan and a display electrically connected to the microprocessor for displaying the remaining useful life of the filter. The microprocessor includes a counter, having a predetermined initial counter value, which counts from the predetermined initial counter value a duration of usage of the fan to determine a present counter value. The microprocessor sends a signal representing the present counter value to the display which uses the signal to display the remaining useful life of the filter.

### CROSS-REFERENCE TO RELATED APPLICATIONS

This application claims the benefit of U.S. Provisional Application No. 60/176,355, filed Jan. 14, 2000.

### FIELD OF THE INVENTION

The present invention relates generally to filter-fan products including a filter monitoring system and more particularly relates to a filter monitoring system using a counter that works in conjunction with the fan motor speed. The system will provide a display for remaining filter life for filter-fan products.

### BACKGROUND OF THE INVENTION

Filter-fan products such as some types of portable fans, air purifiers, humidifiers and dehumidifiers include filters for removing airborne particles from the homes or offices in which they operate. Such filters include fine particle high efficiency particulate air (HEPA) filters, filters for trapping relatively large particles and carbon filters to remove odors.

Typically, a fan is positioned adjacent a removable filter to force air through the filter thereby trapping airborne particles therein. As the efficiency of these types of products depends upon the replacement of the filter when spent, the ability to easily determine when the filter is spent is important. With conventional filter-fan products, the filter is typically replaced only when a visual inspection reveals a spent filter. However, this requires periodic inspection and by the time a filter shows signs of needing replacement, its efficiency has already been drastically reduced. Another option for maintaining the efficiency of the filter-fan product is to follow the manufacturer's filter replacement schedule. However, this requires the user to somehow keep track of the filter-fan product's use. Neither of these options are particularly convenient for the user of the filter-fan product.

Accordingly, it is desirable to provide such fan-filter products with a system to monitor the remaining life of a filter and to indicate when the filter should be replaced. What is needed is an easily viewable display on the filter-fan product alerting the user to the status of the filter.

### SUMMARY OF THE INVENTION

The present invention is a method and circuit for monitoring the useful life of a filter for a filter-fan product. The method according to the present invention generally includes the steps of detecting use of a fan of the filter-fan product with a microprocessor, counting from a predetermined initial counter value a duration of usage of the fan with a counter of the microprocessor to determine a present counter value, calculating by the microprocessor a percentage of filter life remaining based on the present counter value, sending a signal representing the percentage of filter life remaining from the microprocessor to a display and displaying the remaining useful life of the filter based on the signal received from the micro processor.

Preferably, use of the fan is detected by detecting a position of a fan speed switch such that the microprocessor detects the speed of the fan and adjusts the rate of counting by the counter based on the detected speed of the fan. The method further preferably includes the steps of storing the present counter value in a memory device upon termination of fan use, retrieving the stored present counter value from the memory device upon reactivation of the fan and resetting the present counter value to the predetermined initial counter value upon replacement of the filter. The remaining useful life of the filter is preferably displayed by illuminating one of a plurality of light emitting devices, each light emitting device representing a level of remaining useful life of the filter.

The circuit according to the present invention generally includes a microprocessor electrically connected to a power circuit for a fan assembly of the filter-fan product for detecting use of the fan and a display electrically connected to the microprocessor for displaying the remaining useful life of the filter. The microprocessor includes a counter, having a predetermined initial counter value, and an algorithm. The counter counts from the predetermined initial counter value a duration of usage of the fan to determine a present counter value and the algorithm calculates a percentage of filter life remaining based on the present counter value. The microprocessor sends a signal representing the percentage of filter life remaining to the display which uses the signal to display the remaining useful life of the filter.

Preferably, the microprocessor is electrically connected to a fan speed selection switch so that the microprocessor detects a selected fan speed and adjusts the rate of counting by the counter based on the detected fan speed. The fan speed selection switch is positionable to one of a plurality of positions, each position being electrically connected to an input of the microprocessor, wherein the microprocessor detects the selected fan speed by sampling each microprocessor input. The display preferably comprises a plurality of light emitting devices, one of the light emitting devices being illuminated to display a level of remaining useful life of the filter.

The circuit further preferably includes a memory device for storing the present counter value upon termination of fan use and for retrieving the present counter value by the microprocessor upon reactivation of the fan. Additionally, the circuit preferably includes a reset switch for resetting the present counter value to the predetermined initial counter value upon replacement of the filter.

For a better understanding of the present invention, reference is made to the following detailed description to be read in conjunction with the accompanying drawings and its scope will be defined in the appended claims.

### BRIEF DESCRIPTION OF THE DRAWINGS

FIG. 1 is a cross-sectional view of a filter-fan product having a filter monitoring system in accordance with the present invention.

FIG. 2 is a simplified circuit diagram showing a preferred embodiment of the filter monitoring system in accordance with the present invention.

FIG. 3 is a simplified circuit diagram showing an alternate embodiment of the filter monitoring system in accordance with the present invention.

FIG. 4 is a simplified circuit diagram showing another alternate embodiment of the filter monitoring system in accordance with the present invention.

FIG. 5 is a block circuit diagram of the preferred embodiment of the filter monitoring system in accordance with the present invention.

FIG. 6 is a detailed schematic diagram of the preferred embodiment of the filter monitoring system in accordance with the present invention.

FIG. 7 is a schematic diagram of a printed circuit board of the present invention.

### DETAILED DESCRIPTION OF THE PREFERRED EMBODIMENTS

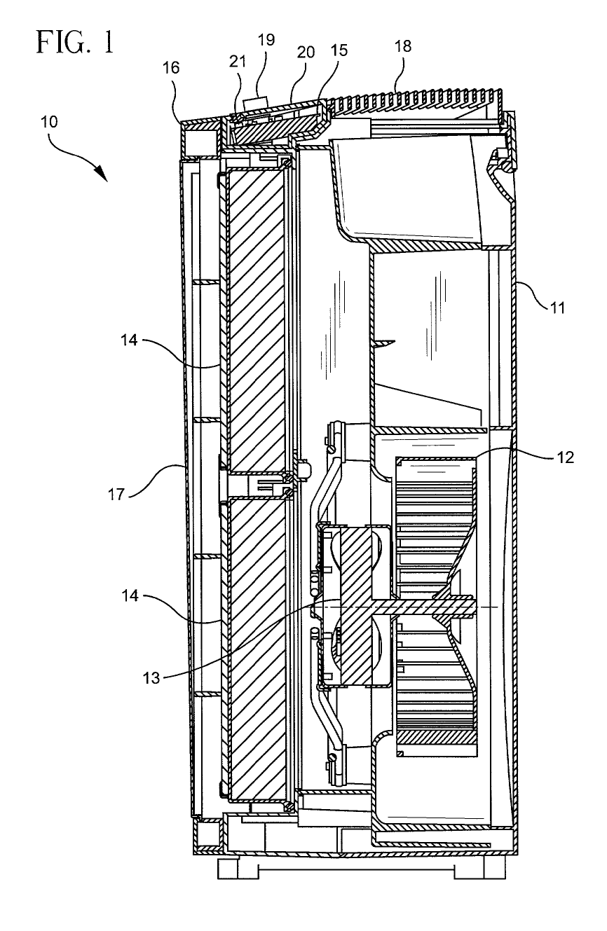

FIG. 1 illustrates a cross-section through an air purifier 10 having the present invention incorporated therein. Although an air purifier is shown, the present invention can be used with any type of fan product utilizing a filter including, but not limited to fans, air conditioners, humidifiers and dehumidifiers. The air purifier 10, shown in FIG. 1, generally includes a housing 11, a fan 12, a fan motor 13, one or more filter assemblies 14 and electronic power circuitry 15 for operating the air purifier. The housing 11 may include a door 16, to facilitate replacement of the filter assemblies 14, and a perforated intake grille 17 and a perforated outlet grille 18, to allow the flow of air through the air purifier 10. The electronic power circuitry 15, which will be discussed in further detail below, generally includes a fan motor switch 19, for selecting the speed of the fan motor 13, a display 20 and a microprocessor 21. In operation, the rotation of the fan 12 causes air to be drawn through the intake grille 17 and into the filter assemblies 14 where the airborne particles are removed before the air exits through the outlet grille 18. This exemplifies the basic operation of a typical filter-fan device that uses replaceable filter assemblies.

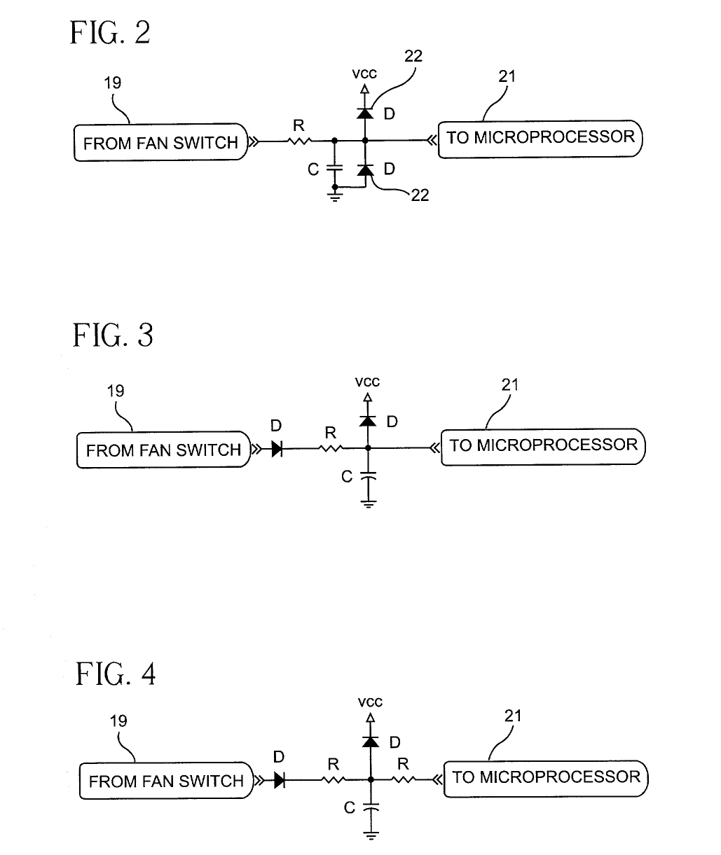

However, to monitor the remaining life of the filter assemblies 14, and to thus determine when they need replacement, the present invention includes unique electronic circuitry 15 to monitor and “count” the use of the fan motor 13. Generally, each position of the fan switch 19 is connected to an input of the microprocessor 21 which “counts” usage of the fan motor based on fan motor speed. The fan switch 19 discussed hereinafter includes positions for “off”, “low”, “medium”, “high” and “sleep” (intermittent), however, switches having fewer or more positions may be utilized with the present invention. FIGS. 2-4 are simplified circuit diagrams illustrating alternate approaches for detecting present fan speed.

In the preferred embodiment, as shown in FIG. 2, each position of the fan switch 19 is wired to an input of the microprocessor 21 through a similar circuit including diodes 22 and an RC network. As a result, AC voltage present at the fan switch positions results in an AC waveform at the microprocessor inputs. The microprocessor 21 is programmed to determine which inputs are active and, from the lack of activity at one input, determines which position the fan speed switch 19 is in. The diodes 22 are used to clamp the voltage at the microprocessor input (i.e., to prevent the input from exceeding the power supply voltage or becoming more negative than ground).

In an alternate embodiment, as shown in FIG. 3, each position of the fan switch 19 is wired to an input of the microprocessor 21 through a similar circuit. AC voltage present at the fan switch positions is detected by a series diode and R/C network. This detector creates a dc voltage at the microprocessor input. In normal operation, the inactive inputs of the microprocessor 21 will have voltage, and the input corresponding to the selected speed will not. The additional diode is used to clamp the voltage at the microprocessor input (i.e., to prevent the input from exceeding the power supply voltage).

In another alternate embodiment, as shown in FIG. 4, the same circuit topology (with somewhat different values) is used. Unlike FIGS. 2 and 3 however, only one circuit is required to be connected to one of the fan switch positions. In this circuit, the capacitor is increased in value so that it requires many milliseconds for it to charge from the filter switch input. The additional resistor between the microprocessor input and the capacitor allows the microprocessor to change its input to output mode. In output mode, the microprocessor can discharge the capacitor. Then, if the microprocessor switches back to input mode, and by measuring the time that is required for the input to reach a logic ‘1’ level, a measurement of the voltage at the fan switch position may be ascertained. Then, by comparing the measured voltage against a table of expected voltages for different fan switch positions, the fan switch position may be ascertained.

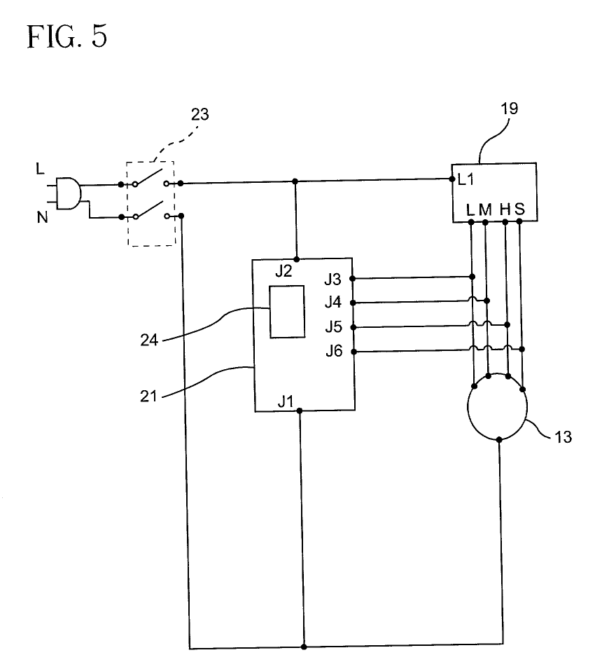

Referring now to FIG. 5, the preferred embodiment of the present invention as shown in FIG. 2 is shown in further detail. The fan switch 19 allows for manual selection of the speed of the fan motor 13. The positions are designated “L1” for off, “L” for low, “M” for medium, “H” for high and “S” for sleep in FIG. 5. As described above, each position of the fan switch 19 is connected to an input of the microprocessor 21 designated J2, J3, J4, J5 and J6, respectively, in FIG. 5. FIG. 5 also shows microprocessor inputs J1 and J2 connected to an optional door switch 23 to terminate power to the motor 13 when the device's filter door 16 is ajar. As will be described in further detail below, the microprocessor 21 includes a counter 24 which “counts” usage of the fan motor based on the selected fan motor speed.

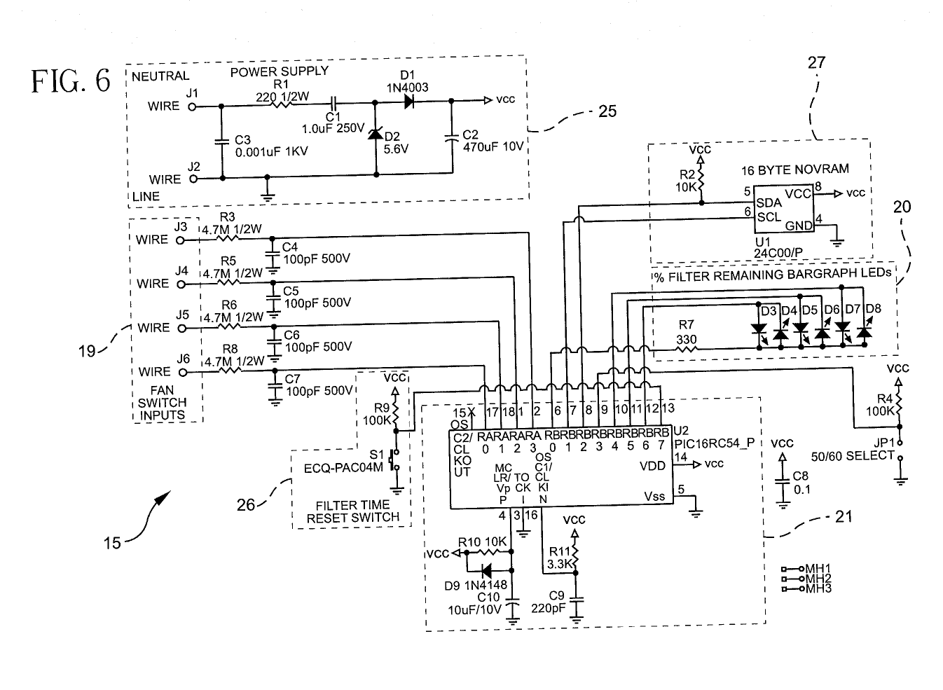

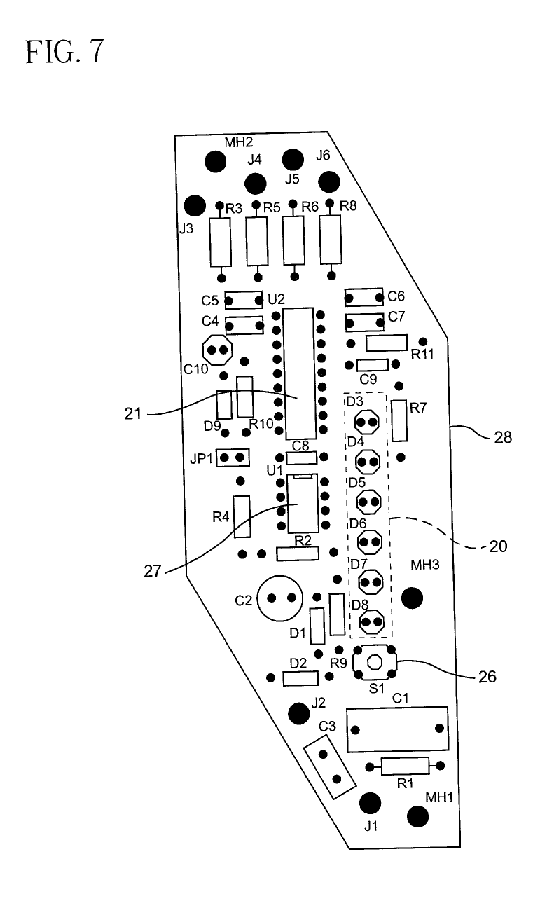

FIG. 6 is a detailed schematic diagram showing the electronic circuitry 15 in accordance with the preferred embodiment of the present invention as shown in FIGS. 2 and 5. The circuitry 15 generally includes the fan motor switch 19, the display 20, the microprocessor 21, a power supply 25, a filter time reset switch 26 and a non-volatile memory storage (NOVRAM) 27. The circuitry 15 is preferably incorporated into a PCB 28 as shown in FIG. 6. The PCB 28 is preferably a single-sided design (i.e. tracks on etch side only, no plated-through holes), with the components mounted to the board using through-hole technology. This board design will allow for panelization.

The power supply 25 uses a capacitive dropping design since general experience has shown that the capacitive type of supply is more reliable. This design provides fifteen milliamperes of current required to operate the microprocessor 21, the memory 27 and the display 20. The power supply 25 has an operating voltage of 115 VAC, 60 hertz and 230 VAC, 50 Hertz. (At the required current level, a resistive dropping design would have required the dissipation of multiple watts of power in the 230 VAC model.)

The non-volatile memory storage 27 preferably has the capability for running up to 30,000 hours before 100% usage is reached. Design life of the memory should exceed 10 years in continuous use and, preferably, no battery of any type is used. A suitable memory device is Part No. 24C00 (available in 8 pin DIP) manufactured by Microchip and other sources. This device uses an I²C interface, requiring only clock and data lines from the microprocessor 21. The device is specified for 1,000,000 write cycles. As described below, the present program writes the device every 770 seconds. Thus, at this frequency, the memory will be written 410,000 times in ten years.

A number of microprocessors from different suppliers can be used in the present invention. Table 1 below lists several alternatives:

TABLE 1

| MFR | PART | NOTES |
|---|---|---|
| Atmel | Atiny 11 | 1K Flash, 8 Pin DIP |
| Atmel | Atiny 12 | 1K Flash, 64 byte Nov, 8 Pin DIP |
| Microchip | 16CR54 | 512 Mask ROM, 18 pin DIP |
| Microchip | 12CR509 | 1024 Mask ROM, 8 pin DIP |
| Microchip | 16CR620 | 512w Mask ROM, 18 pin DIP |
| Motorola | MC68HC05K0 | 512b Mask ROM, 16 pin DIP |
| Zilog | Z86C02 | 512b Mask ROM, 18 pin DIP |
| Zilog | Z8E000 | 512b OTP ROM, 18 pin DIP |

However, it has been found that the preferred microprocessor is the Microchip PIC16CR54C device. This device allows for minimal external support componentry while providing adequate RAM and Program Memory for the filter check application. For example, the Microchip device includes internal diodes for clamping the voltage at the microprocessor input (diodes 22 shown in FIG. 2). Additionally, the Microchip microprocessor provides an external RC oscillator and external reset circuitry components. Development for the microprocessor 21 is performed using OTP parts in the Microchip MPLAB environment using assembly and/or C Language.

The display 20 comprises six LEDs D3, D4, D5, D6, D7 and D8. Preferably, the LEDs are six discrete T1 3/4 LEDs including four green, one amber, one red only one of which are illuminated at one time. The LEDs are controlled by the microprocessor to indicate “Filter Life Remaining” in a vertical bar. Initially this display is lit at a 100% level. As the fan is run, the lit level drops over time until the 0% LED is lit. The following Table 2 defines which LED is lit as a function of percentage of “Filter Life Remaining”:

TABLE 2

| LED | Color | % Life Remaining |
|---|---|---|
| 3 (top) | GRN | >80% to 100% |
| 4 | GRN | >60% to 80% |
| 5 | GRN | >40% to 60% |
| 6 | GRN | >20% to 40% |
| 7 | YEL | >0.0% to 20% |
| 8 (bottom) | RED | 0.0% |

The percentage of filter life remaining is determined by a program in the microprocessor 21 that is based on a straight-line linear relationship between total time of fan use and filter life remaining. Predetermined values for total filter life relative to fan speed are programmed into the microprocessor 21 and are used as baseline variables by the microprocessor program to determine filter life remaining. For example, it may be known that a particular filter has a life of 8,760 hours with a fan running at full speed. Inputting this value into the microprocessor's program will result in the microprocessor illuminating the red LCD D8, indicating 0%, after the fan has run at full speed for 8,760 hours. Accordingly, values for total filter life relative to other fan speeds can be calculated based on this value. Table 3 below shows exemplary predetermined baseline variables for programming the microprocessor.

TABLE 3

| Fan Speed | Filter Life |
|---|---|
| H (Fastest) | 8,760 hours (1 yr) |
| M | 10,950 hours |
| L (Slowest) | 14,600 hours |
| S (Sleep) | 21,900 hours (2.5 yr) |

The microprocessor 21 then “counts” down based on these starting values and on actual fan use at the detected fan speed. In operation, the microprocessor functions in the following manner. The microprocessor 21 includes a RC clock that runs the microprocessor at 800 kHz. The processor divides this rate by four to achieve a 200 kHz nominal instruction speed (5 μsec per instruction). This frequency may be as low as 180 kHz or as high as 220 kHz depending on component tolerances and regulated voltage. Whenever the processor is reset, or the processor detects the fan turning on, the unit is initialized, and a display test is run. This test lights each of the display LEDs in order for ⅓ second starting at the top (green) LED and finishing with the bottom (red) LED. The display then blanks for one second. Finally, normal operation starts, and the LED associated with the present filter life remaining is lit.

Fan speed detection is implemented in the microprocessor firmware by continuously sampling the four fan speed switch inputs for transitions. Transitions are counted for each input using individual 8 bit counters. When the largest count is greater than the selected line frequency, then the sampling counters are serviced. Any counter that is less than ½ the value of the largest counter is set to be zero. The counters are reviewed in order, from the counter associated with the highest speed input to that associated with the slowest. The first zero counter detected establishes the present fan speed. If no zero counter is detected, the fan is assumed to be off. If the fan is detected as off twice in succession (for two seconds), the unit blanks the display. If the display is blanked, and a fan position is detected, the unit proceeds to the power-up test and display. After detecting fan speed in normal operation, the input counters are then decremented by 60 or 50 (the selected line frequency). Counters are zeroed if their value is less than line frequency. At this point, fan speed has been detected, and one second of filter life has been measured. From this point the filter life calculation proceeds.

At the time that the input counters are decremented (and one second of life has been measured), a prescaler is decremented. The amount the prescaler is decremented depends on the detected fan speed. At the fastest fan speed, the prescaler reaches zero every five seconds (12.5 seconds at the slowest speed). When this prescaler rolls, another following prescaler is decremented. This following prescaler reaches zero every 770 seconds at the fastest fan speed. The following prescaler decrements the filter life counter. This counter is a two byte value. Whenever this counter is decremented, it is re-written in triplicate to NOVRAM 27. The top three bits of this counter are displayed on the LED bar-graph. This counter is initially loaded to a predetermined initial counter value. The following Table 4, illustrates exemplary predetermined counter values for a given filter.

TABLE 4

| | | % Life | Life Counter | | Span | |
|---|---|---|---|---|---|---|
| LED # | Color | Initially | Initial | Final | Init-Final | Days |
| 6 | Grn | 100 | 57343 | 49152 | 8192 | 73.01 |
| 5 | Grn | 80 | 49151 | 40960 | 8192 | 73.01 |
| 4 | Grn | 60 | 40959 | 32768 | 8192 | 73.01 |
| 3 | Grn | 40 | 32767 | 24576 | 8192 | 73.01 |
| 2 | Yel | 20 | 24575 | 16384 | 8192 | 73.01 |
| 1 | Red | 0 | 16383 | 8192 | | |
| | | | | | 40960 | 365.04 |

As shown in Table 4, the value 57,343 will light the 6^{th} LED (top green LED). With the prescaler arrangement described, the life counter will decrement to 49,151 after 73.01 days of fan use at the highest speed. At this point, the 6^{th} LED will turn off, and the 5^{th} LED will light. As the counter continues to decrement, the LEDs are lit as indicated in Table 4.

After a filter has been changed, the filter life display 20 may be reset by depressing the filter life reset switch 26. Preferably, the reset switch 26 is located below the LED display, as shown in FIG. 6, and is accessible through a small hole (⅛″ diameter) in the housing 11 of the air purifier 10. To achieve reset, the user must depress and hold the switch for several seconds. When the user depresses this switch, the time remaining display shall return to 100% (i.e. the top green LED will light) and the filter life counter is reset to 57343.

Provided below in Table 5 is a complete bill-of-materials for each electronic component illustrated in FIG. 6, including a preferred value of resistance, capacitance, and component types. It will be understood by those skilled in the art that similar components with varying values may be used to accomplish the objectives of the invention without departing from the spirit of the invention.

TABLE 5

| Designator | Description |
|---|---|
| C1 | Capacitor, Metallized Polyester Film, 1.0 μF, 250 V |
| C2 | Capacitor, Aluminum Electrolytic, Radial, 470 μF, 10 V |
| C3 | Capacitor, Ceramic Disk, 0.001 μF, 1KV |
| C4,C5,C6,C7 | Capacitor, Ceramic Disk, 100 pF, 500 V |
| C8 | Capacitor, Ceramic, Axial, Z5U, 0.1 μF, 50 V |
| C9 | Capacitor, Ceramic, Axial, NPO, 220 pF, 100 V |
| C10 | Capacitor, Aluminum Electrolytic, Radial, 10 μF, 16 V |
| D1 | Diode, Rectifier, 200 V, 1A, DO41 |
| D2 | Diode, Zener, 1.0 W, 5.8 V, DO41 |
| D8 | LED, T1-¾, , Red, Diffused |
| D7 | LED, T1-¾, , Yellow, Diffused |
| D3,D4,D5,D6 | LED, T1-¾, , Green, Diffused |
| D9 | Diode, Rectifier, GP, D035 |
| R1 | Resistor, CF, 220 ohms, 1/2 W, 5% |
| R2,R10 | Resistor, CF, 10 K ohms, 1/4 W, 5% |
| R3,R5,R6,R8 | Resistor, CF, 4.7 M ohms, 1/2 W, 5% |
| R7 | Resistor, CF, 330 ohms, 1/4 W, 5% |
| R4,R9 | Resistor, CF, 100 K ohms, 1/4 W, 5% |
| R11 | Resistor, CF, 3.3 K ohms, 1/4 W, 5% |
| S1 | Switch, Pushbutton, 6X6 mm |
| U1 | IC, CMOS, Serial Eeprom, 16 × 8 |
| U2 | IC, CMOS, Micro, 8 Bit, 512 × 12, OTP |
| PCB1 | Printed Circuit Board, 2″ × 3″, Single Sided |

While there has been described what is presently believed to be the preferred embodiments of the invention, those skilled in the art will realize that various changes and modifications may be made to the invention without the parting from the spirit of the invention and it is intended to claim all such changes and modifications as fall within the true scope of the invention.

What is claimed is:

1. A method for monitoring the useful life of a filter for a filter-fan product comprising the steps of:
detecting use of a fan of the filter-fan product with a microprocessor;
counting from a predetermined initial counter value a duration of usage of the fan with a counter of the microprocessor to determine a present counter value;
calculating by the microprocessor a percentage of filter life remaining based on the present counter value;
sending a signal representing the percentage of filter life remaining from the microprocessor to a display; and
displaying the remaining useful life of the filter based on the signal received from the microprocessor.

2. The method as defined in claim 1, wherein use of the fan is detected by detecting a position of a fan speed switch.

3. The method as defined in claim 1, further comprising the steps of:
detecting the speed of the fan with the microprocessor; and
adjusting the rate of counting by the counter based on the detected speed of the fan.

4. The method as defined in claim 3, wherein the speed of the fan is detected by detecting a position of a fan speed switch.

5. The method as defined in claim 1, further comprising the step of resetting the present counter value to the predetermined initial counter value upon replacement of the filter

6. The method as defined in claim 1, wherein the step of displaying the remaining useful life of the filter includes the step of illuminating one of a plurality of light emitting devices, each light emitting device representing a level of remaining useful life of the filter.

7. The method as defined in claim 1, further comprising the step of storing the present counter value in a memory device upon termination of fan use.

8. The method as defined in claim 7, further comprising the step of retrieving the stored present counter value from the memory device upon reactivation of the fan.

9. A circuit for monitoring the useful life of a filter used in a filter-fan product comprising:
a microprocessor electrically connected to a power circuit for a fan assembly of the filter-fan product for detecting use of the fan, the microprocessor including a counter having a predetermined initial counter value and an algorithm, the counter counting from the predetermined initial counter value a duration of usage of the fan to determine a present counter value and the algorithm calculating a percentage of filter life remaining based on the present counter value and generating a signal corresponding thereto; and
a display electrically connected to the microprocessor for receiving the signal corresponding to the percentage of filter life remaining from the microprocessor and displaying the remaining useful life of the filter.

10. The circuit as defined in claim 9, wherein the microprocessor is electrically connected to a switch of the fan assembly power circuit for detecting use of the fan.

11. The circuit as defined in claim 10, wherein the switch is a fan speed selection switch, the microprocessor further detecting a selected fan speed and adjusting the rate of counting by the counter based on the detected fan speed.

12. The circuit as defined in claim 11, wherein the fan speed selection switch is positionable to one of a plurality of positions, each position being electrically connected to an input of the microprocessor, wherein the microprocessor detects the selected fan speed by sampling each microprocessor input.

13. The circuit as defined in claim 9, further comprising a reset switch for resetting the present counter value to the predetermined initial counter value upon replacement of the filter.

14. The circuit as defined in claim 9, wherein the display comprises a plurality of light emitting devices, one of the light emitting devices being illuminated to display a level of remaining useful life of the filter.

15. The circuit as defined in claim 9, further comprising a memory device for storing the present counter value upon termination of fan use and for retrieving the present counter value by the microprocessor upon reactivation of the fan.
